(19) United States
(12) Patent Application Publication
(10) Pub. No.: US 2026/0239119 A1
(43) Pub. Date: Aug. 13, 2026

(54) PRIORITIZATION FOR CONDITIONAL HANDOVER

(71) Applicant: InterDigital Patent Holdings, Inc., Wilmington, DE (US)

(72) Inventors: Oumer Teyeb, Montreal (CA); Faris Alfarhan, Montreal (CA); Umer Salim, Vallauris (FR); Brian Martin, Farnham (GB); Paul Marinier, Brossard (CA)

(73) Assignee: InterDigital Patent Holdings, Inc., Wilmington, DE (US)

(21) Appl. No.: 19/471,118

(22) PCT Filed: Apr. 2, 2024
(86) PCT No.: PCT/US2024/022611

§ 371 Date: Sep. 30, 2025

Related U.S. Application Data
(60) Provisional application No. 63/456,885, filed on Apr. 4, 2023.

(51) Int. Cl. H04W 36/00; H04W 36/36

(52) U.S. Cl. CPC H04W 36/0061; H04W 36/00835; H04W 36/00837; H04W 36/362

(57) ABSTRACT

A WTRU may receive configuration information associated with CHO for a set of stable cells and/or non-stable cells. The WTRU may receive a CHO priority indication that includes an indication to prioritize stable cells for CHO or an indication to prioritize non-stable cells for CHO. The CHO priority indication may be received via at least one of: the received configuration information associated with CHO for the set of stable cells, or the received configuration information associated with CHO for the set of non-stable cells. The WTRU may determine whether at least one CHO triggering condition is met for a cell in response to a CHO trigger based on the received CHO priority indication. For example, the received CHO priority indication may be an indication that a serving cell is to enter an NES state and/or an of a time that the serving cell is to enter the NES state.

### CROSS REFERNCE TO RELATED APPLICATIONS

This patent application claims the benefit of U.S. Provisional Patent Application No. 63/456,885 filed Apr. 4, 2023, the entire contents of which is incorporated herein by reference in its entirety.

### BACKGROUND

Certain networks may employ network energy savings techniques, for example, to enable the network to minimize the power consumption associated with transmission and reception. Such minimization may serve to reduce operational costs and/or environmental sustainability.

### SUMMARY

A WTRU may receive configuration information associated with conditional handover (CHO) for a set of stable cells. The WTRU may also receive configuration information associated with CHO for a set of non-stable cells. The WTRU may receive a CHO priority indication (e.g., via a transmission). For example, the CHO priority indication may include an indication to prioritize stable cells for CHO or an indication to prioritize non-stable cells for CHO. The CHO priority indication may be received via at least one of: the received configuration information associated with CHO for the set of stable cells, or the received configuration information associated with CHO for the set of non-stable cells. The WTRU may determine whether at least one CHO triggering condition is met for a cell in response to a CHO trigger based on the received CHO priority indication. For example, the received CHO priority indication may be an indication that a serving cell associated with the WTRU is to enter an NES state and/or an indication of a time that the serving cell associated with the WTRU is to enter the NES state.

In certain scenarios, the CHO priority indication may include the indication to prioritize stable cells. If the CHO priority indication includes the indication to prioritize stable cells, the WTRU may determine that the at least one CHO triggering condition is not met for any cell in the set of stable cells during a first period time. in response to the determination that the CHO triggering conditions is not met for any cell in the set of stable cells during the first period time, the WTRU may determine whether the at least one CHO triggering condition is met for any cell in the set of stable cells or any cell in the set of non-stable cells during a second period time. The WTRU may also, or alternatively, determine that the at least one CHO triggering condition is not met for any cell in the set of stable cells or any cell in the set of non-stable cells during the second period time. In response to the determination that the at least one CHO triggering condition is not met for any cell in the set of stable cells or any cell in the set of non-stable cells during the second period time, the WTRU may send an indication that includes information associated with the determination that the CHO triggering conditions is not met for any cell in the set of stable cells during the first period time and the determination that the at least one CHO triggering condition is not met for any cell in the set of stable cells or any cell in the set of non-stable cells during the second period time.

A WTRU may be configured to receive configuration information associated with conditional handover (CHO) for a set of stable cells, and configuration information associated with CHO for a set of non-stable cells. The WTRU may receive a priority indication (e.g., a CHO priority indication) that comprises an indication to prioritize stable cells or an indication to prioritize non-stable cells. The WTRU may determine whether a CHO triggering condition is met for any cell in a first set of cells based on the CHO priority indication. If, for example, the CHO priority indication comprises the indication to prioritize stable cells, the WTRU may determine that the CHO triggering conditions is not met for any cell in the first set of cells (e.g., stable cells) during a first period time. And, in response to the determination that the CHO triggering conditions is not met for any cell in the first set of cells during the first period time, the WTRU may determine whether the CHO triggering conditions is met for any cell in the first set of cells or a second set of cells during a second period time. If, for example, the WTRU determines that the CHO triggering conditions is not met for any cell in the first set of cells or the second set of cells during the second period time, the WTRU may send an indication that includes a result that determination.

A WTRU may be configured to fallback to alternative/stable cells when the WTRU is unable to perform CHO to non-stable cells (e.g., or vice versa). One or more of the following may apply. For example, the WTRU may be configured to fallback to alternative/stable cells to prevent overloading in stable cells (e.g., to prevent a situation where all/most of the WTRU execute a CHO to stable cells upon detecting NES state change of their serving cells) and/or to expediate energy saving over a given area (e.g., when the stable cells are not overloaded).

A WTRU may be configured with CHO configurations towards stable cells (e.g., macro cells that won't be turned off) and/or non-stable cells (e.g., NES capable micro cells). The WTRU may be further configured to determine whether to evaluate/execute CHO towards a stable cell, e.g., if (e.g., only if) the WTRU is unable to trigger the CHO to a non-stable cell (e.g., or vice versa). The WTRU may be configured with a CHO towards one or more stable cells (e.g., cells that will never be turned off, e.g., macro cells). The WTRU may be configured with a CHO towards one or more non-stable cells (e.g., cells that support NES and may be turned off). The WTRU may prioritize CHO towards the stable cells and/or the non-stable cells. The WTRU may be configured with the prioritization (e.g., prioritize stable cells or prioritize non-stable cells) as part of the CHO configurations or another configuration (e.g., dedicated signaling or broadcast/group signaling). For example, the priority configuration may include a first time duration (e.g., prioritization_duration) which may indicate the period of time that the configured priority is active. The priority configuration may also include a second time duration that indicates a time duration after the first time duration has elapsed. The WTRU may receive an indication to start evaluating the CHO triggering conditions. For example, the indication may inform the WTRU that a serving cell may start operating in NES mode within a given time. If, for example, stable cells were prioritized, the WTRU may evaluate the CHO triggering conditions towards the stable cells. If, however, non-stable cells are prioritized, the WTRU may evaluate the CHO triggering conditions towards the non-stable cells.

If the WTRU identifies a cell (e.g., stable cell if stable cells are prioritized, non-stable cell if non-stable cell are prioritized) that satisfies the triggering conditions of the CHO before the prioritization_duration has elapsed, the WTRU may execute the CHO towards the concerned stable or non-stable cell and send an indication of the CHO to the network.

If, however, the WTRU does identify not a cell that satisfies the triggering conditions of the CHO before the prioritization_duration elapses, the WTRU may evaluate the CHO triggering conditions for both stable and non-stable cells. If the WTRU finds a stable/non-stable cell that fulfills the CHO triggering conditions before the second time duration has elapsed, the WTRU may execute the CHO towards the concerned stable/non-stable cell and send an indication to the network. Otherwise, the WTRU may send an indication to the network that the WTRU failed to identify a stable or non-stable target that fulfills the CHO conditions.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example associated with conditional handover (CHO) configuration and execution.

FIG. 3 illustrates an example associated with prioritized CHO.

### DETAILED DESCRIPTION

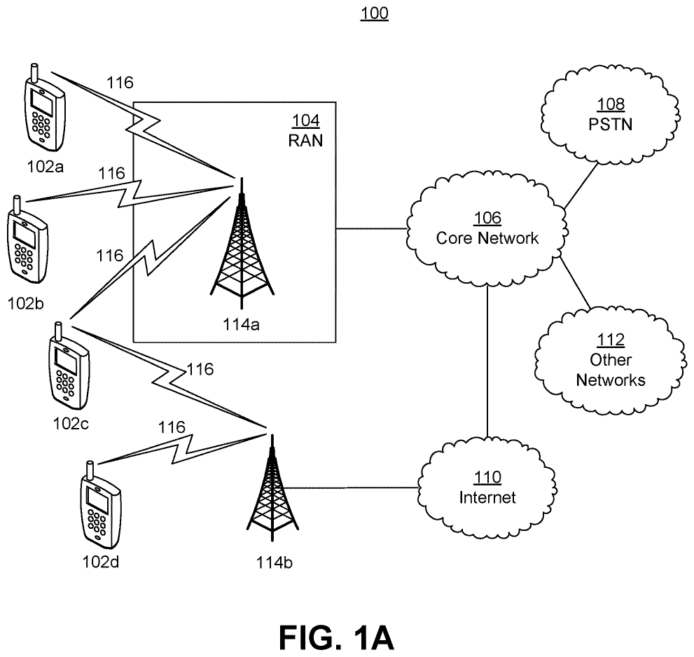

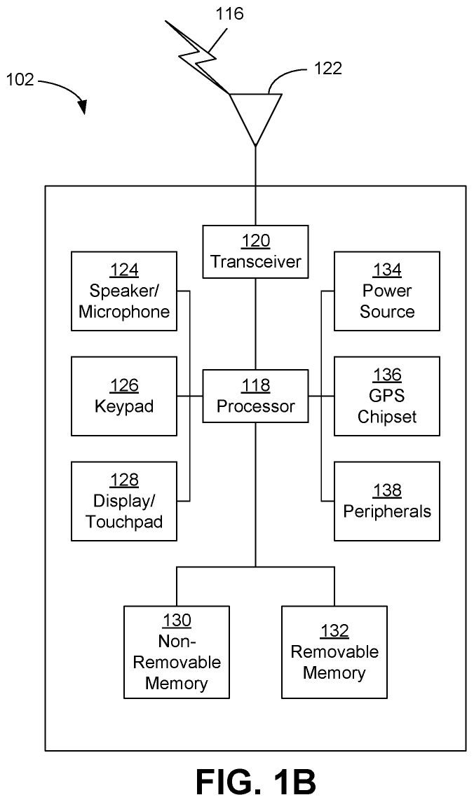

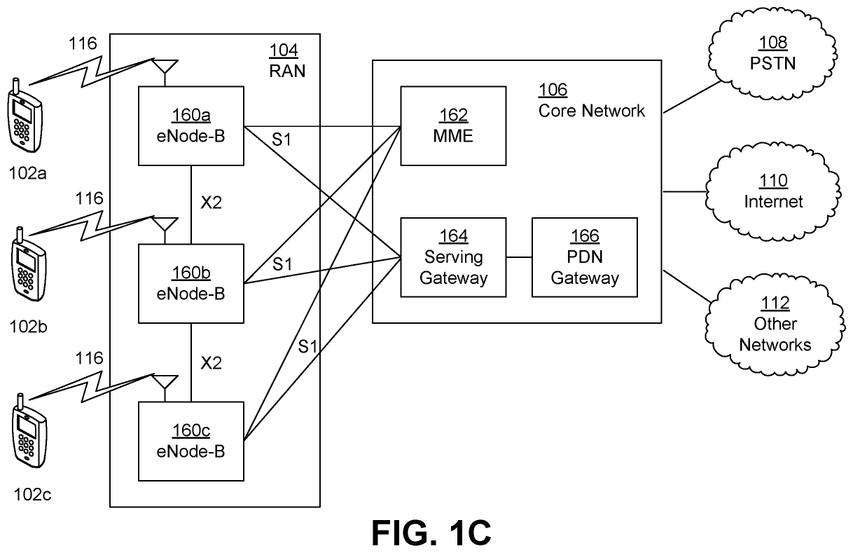

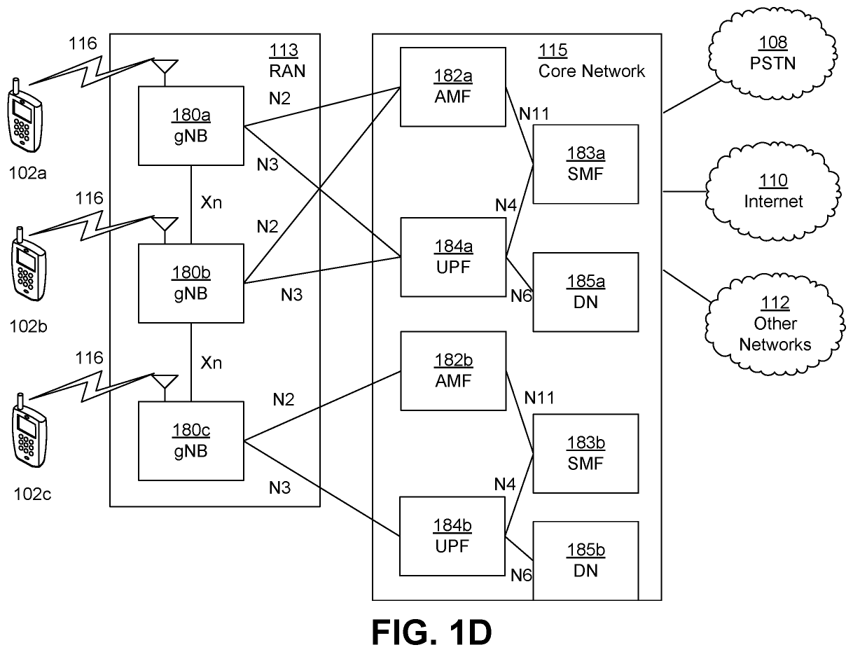

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-3 word DFT-spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc. and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like, The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b.

The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Networks may be configured such that transmissions from the network that do not include data are minimized. For example, always-on cell-specific reference signals (CRS) may not be used in certain networks (e.g., NR). Further energy consumption reduction may be realized.

Networks may also consume energy when not transmitting, e.g., from other activities such as baseband (e.g., digital) processing for reception or beamforming. Such idle power consumption may not be negligible, e.g., in dense networks, even if a WTRU is not being served during a given period. If, for example, networks are able to turn of these activities when not transmitting to a WTRU, energy consumption may be reduced.

Certain networks may not transmit (e.g., require transmission of) always-on synchronization or reference signals, and may support adaptable bandwidth and MIMO capabilities. Network resources may be adapted to increase efficiency in operating newer deployments and later generations.

A WTRU may determine whether it can transmit or receive on certain resources, e.g., depending on a network availability state. For example, the network availability state may indicate a gNB's power savings status. An availability state may correspond to a network energy savings (NES) state, a cell discontinuous transmission (DTX) mode, a cell discontinuous reception (DRX) mode, and/or a gNB activity level. An availability state may be uplink and/or downlink specific, and may change from symbol to symbol, slot to slot, frame to frame, and/or on longer duration granularity. The availability state may be determined by the WTRU and/or indicated by the network. An availability state may be, for example, “On”, “DL and UL active”, “UL only active”, “off”, “reduced Tx power”, “dormant”, “micro sleep”, “light sleep”, “deep sleep,” and/or the like. Such states may be abstracted by one or more network configuration parameters and/or values. For example, an indication (e.g., a dynamic indication) may be used to determine the active availability state (e.g., by DCI or MAC CE signaling). The “Off” availability state may indicate that the gNB's baseband hardware is completely turned off. The “sleep” availability state may indicate that the gNB wakes up periodically to transmit certain signals (e.g., presence signals, synchronization, or reference signals) or receive certain UL signals. In some availability states, for example, certain DL or UL resources are not available during certain periods of time, which may enable the network to turn off baseband processing and other activities. Some measurement resources (e.g., SSBs or CSI-RS) may be (e.g., may only be) made available in certain availability states, for example, including: RLM, BFD, RRM measurements, CSI-RS feedback configuration, and/or a different power offset for CSI feedback.

Under certain conditions, a WTRU may further transmit a request to the network (e.g., a wake-up request) to modify the availability state to a state such that resources that would satisfy the WTRU's requirements are available.

A WTRU may determine an availability state based on the reception of an availability state indication, for example, from by L1/L2 signaling (e.g., a group common DCI or indication). Also, or alternatively, the WTRU may implicitly determine availability state based on the reception of periodic DL signaling (e.g., or lack thereof).

A WTRU may determine that an uplink or downlink resource or signal is available for transmission/reception and/or measurements based on the determined network availability state (e.g., if the downlink resource or signal is applicable in the active availability state). The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals in a subset of (e.g., only in a subset of) network availability states (e.g., sounding reference signals (SRS), pSRS, PRACH, uplink control information (UCI).

A WTRU may perform cell (re-)selection, mobility to another serving cell, trigger mobility related measurements, and/or start evaluating conditional handover (CHO) candidates on alternate cells, for example, based on determining that an NES change on the camped cell or the serving cell has occurred. The WTRU may be configured or predefined with an alternative serving cell to perform initial access, mobility, or cell reselection on, e.g., if the current serving cell or a capacity boosting cell (e.g., a cell not configured as an alternative cell) is turned off and/or a certain condition is met. The WTRU may be configured (e.g., via broadcast or dedicated signaling) with a list of fallback or alternative serving cells, for example, per serving cell, per gNB, per PLMN, and/or per network identity.

A WTRU may initiate a cell reselection or mobility procedure with an alternative serving cell associated with a cell or gNB from which a turn-off indication was received. For example, the turn off or go-to-sleep indication (e.g., via dedicated or broadcast signaling) may be used to dynamically indicate which cell to fallback or connect to the WTRU. The fallback/alternative cell may be configured or predefined to be a cell within the same gNB from which a sector has entered NES state (e.g., off, sleep, or reduced power). Also, or alternatively, the fallback cell may be predefined as the master node cell, e.g., if the WTRU is in dual connectivity. The fallback/alternative cell may be configured or predefined to be a cell associated with a different RAT or frequency band. For example, the WTRU may fallback to an another cell (e.g., an LTE or an FR1 cell) associated with the cell or gNB from which the turn off indication was received (e.g., if the WTRU is configured with carrier aggregation or dual connectivity using multiple RATs or multiple frequency bands).

The terms alternative cell and stable cell may be used interchangeably in this disclosure. A WTRU may be configured with a list of stable cells (e.g., cells that will not turn off, such as, certain macro cells). As described herein, stable cells may include a set of one or more cells that the network does not (e.g., does not intend to) turn off and/or that are not configured (e.g., not currently configured) to enter transition to an NES state. The set of stable cells may change over. For example, as described herein, the network may update the set of stable cells based on measurements performed by WTRU(s). The list of stable cells may include either a list of cells per serving/camped cell or a general list of PCIs for the whole network, tracking area, etc. The WTRU may be configured with a measurement object configuration for the set of stable cells. Stable cells may be preconfigured to be CHO candidates, and/or may be used as CHO candidates if (e.g., only if) the source cell turns off/activates a NES.

Measurement performed by the WTRU may be used by the network for radio resource management (RRM), such as for mobility decisions (e.g., handover).

In RRC_CONNECTED, a WTRU may measure one or more (e.g., multiple) beams associated with a cell. The measurements results (e.g., power values) may be averaged, e.g., to derive the cell quality. The WTRU may be configured to consider a subset of the detected beams. Filtering may be performed at one or more levels. For example, filtering may be performed at the physical layer (e.g., L1) to derive beam quality. Filtering may also, or alternatively, be performed at the RRC layer (e.g., L3) to derive cell quality from multiple beams. Cell quality from beam measurements may be derived in the same way for the serving cell(s) and for the non-serving cell(s).

Measurement reporting configuration may be either event triggered or periodical. If, for example, measurement reporting is periodical, the WTRU may send a measurement report at a (e.g., every) reporting interval. For example, a reporting interval may range between 120 ms and 30 min.

For event triggered measurements, a WTRU may send a measurement report if, for example, the conditions associated with the event are fulfilled. The WTRU may continue to measure, report, and validity (e.g., with a threshold or offset included in the configuration) serving cells and/or neighbor cells in accordance with report configuration. The report quantity/the trigger for event may include be reference signal received power (RSRP), reference signal received quality (RSRQ), or signal to noise ratio (SINR).

Measurement reports may include (e.g., based on the respective configuration) the cell quality of serving cells and/or neighbor cells, and/or the X number of best beams associated with that cell may be include.

The measurement events may include intra-RAT events, and inter-RAT events. Intra-RAT events may include: event A1 (e.g., serving becomes better than threshold); event A2 (e.g., serving becomes worse than threshold); event A3 (e.g., neighbor becomes offset better than SpCell); event A4 (e.g., neighbor becomes better than threshold); event A5 (e.g., SpCell becomes worse than threshold1 and neighbor becomes better than threshold2); and/or event A6 (e.g., neighbor becomes offset better than SCell). Inter-RAT events may include event B1 (e.g., inter RAT neighbor becomes better than threshold); and/or event B2 (e.g., PCell becomes worse than threshold1 and inter RAT neighbor becomes better than threshold2).

Event A1 (e.g., serving becomes better than threshold) may be used to cancel an ongoing handover procedure. Event A1 may be used (e.g., required) if a WTRU moves towards cell edge and triggers a mobility procedure, but then subsequently moves back into good coverage before the mobility procedure has completed.

Event A2 (e.g., serving becomes worse than threshold) may not involve any neighbor cell measurements. Event A2 may be used to trigger a blind mobility procedure. Event A2 may also, or alternatively, be used by the network to configure the WTRU for neighbor cell measurements, for example, when the WTRU receives a measurement report that is triggered due to event A2 in order to save WTRU battery (e.g., not perform neighbor cell measurement when the serving cell quality is good enough).

Event A3 (e.g., neighbor becomes offset better than SpCell) may be used for handover procedure. Am SpCell (e.g., special cell) may be the primary serving cell of either the master cell group (MCG) (e.g., the PCell) or the primary serving cell of the secondary cell group (SCG) (e.g., the PSCell). In DC operation, for example, the secondary node (SN) may configure an A3 event for SN triggered PSCell change. Event A3 may, for example, be used in CHO and CPC.

Event A4 (e.g., neighbor becomes better than threshold) may be used for handover procedures and/or may not depend upon the coverage of the serving cell (e.g., load balancing, where the WTRU is handed over to a good neighbor cell even if the serving cell conditions are excellent).

Event A5 (e.g., SpCell becomes worse than threshold1 and neighbor becomes better than threshold2) may be used for handover. Event A5 (e.g., unlike A3, which may use a relative comparison) may provide a handover triggering mechanism, for example, based upon absolute measurements of the serving and neighbor cell. Event A5 may be used for time critical handover, e.g., when the serving cell becomes weak and it is necessary to change towards another cell which may not satisfy the criteria for an event A3 handover.

Event A6 (e.g., neighbor becomes offset better than SCell) may be used for SCell addition/release.

Event B1 (e.g., Inter RAT neighbor becomes better than threshold) may be similar to event A4, but for the case of inter-RAT handover.

Event B2 (e.g., PCell becomes worse than threshold1 and inter RAT neighbor becomes better than threshold2) may be similar to event A5, but for the case of inter-RAT handover.

Certain networks may implement CHO and conditional PSCell addition (CPA)/Change (CPC) (collectively CPAC). For example, CHO and CPAC may be used to reduce the likelihood of radio link failures (RLF) and/or handover failures (HOF).

In certain networks, handover may be triggered by measurement reports, e.g., even if the network is not prevented from sending a HO command to a WTRU without receiving a measurement report from the WTRU. For example, the WTRU may be configured with an A3 event that triggers a measurement report to be sent when the radio signal level/quality (RSRP, RSRQ, etc.) of a neighbor cell becomes better than the primary serving cell (PCell) (e.g., or the radio signal level/quality of a neighbor cell becomes better than Primary Secondary serving Cell (PSCell) in the case of dual connectivity). The WTRU may monitor the serving and neighbor cells and send a measurement report if certain conditions are satisfied. When such a report is received, the network (e.g., the current serving node/cell) may prepare and send a HO command (e.g., an RRC Reconfiguration message, with a reconfiguration WithSync) to the WTRU. The WTRY may, in response to receiving the HO command, execute (e.g., immediately execute) handover, resulting in WTRU connecting to the target cell.

CHO may differ from other handover techniques. For example, in CHO, multiple handover targets may be prepared (e.g., as compared to only one target in other handover techniques). Also, or alternatively, a WTRU may not always immediately execute CHO in response to receiving a HO command. Instead, the WTRU may be configured with triggering conditions (e.g., a set of radio conditions), and the WTRU may execute the handover towards one of the targets if (e.g., only if) the triggering conditions are fulfilled.

A CHO command may be sent when radio conditions towards the current serving cells are favorable, thereby reducing the likelihood of handover failure. For example, HO failure may occur if measurement report fails to be sent (e.g., if the link quality to the current serving cell falls below acceptable levels when the measurement reports are triggered in normal handover). For example, HO failure may occur if the WTRU fails to receive the handover command (e.g., if the link quality to the current serving cell falls below acceptable levels after the WTRU has sent the measurement report, but before it has received the HO command).

The triggering conditions for a CHO may also be based on the radio quality of the serving cells and neighbor cells (e.g., such as the conditions that are used in to trigger measurement reports). For example, a WTRU may be configured with a CHO that has an A3 like triggering conditions and associated HO command. The WTRU may monitor the current and serving cells and when the A3 triggering conditions are fulfilled, the WTRU may executes the associated HO command and switches its connection towards the target cell (e.g., instead of sending a measurement report).

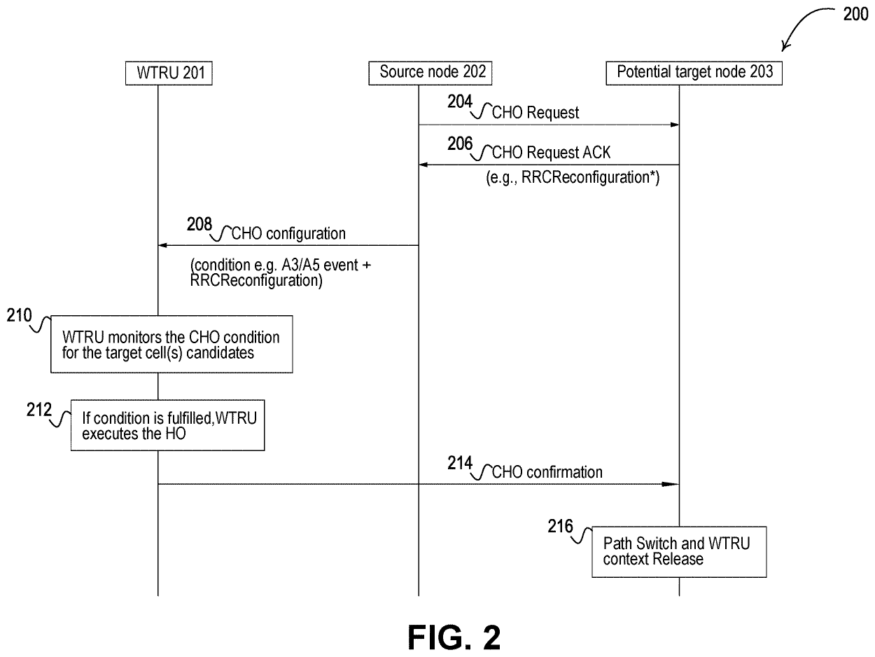

FIG. 2 illustrates an example 200 associated with CHO configuration and execution for a WTRU 201, a source node 202, and a potential target node 203. At 204, the source node 202 may send a CHO request to the potential target node 203. The potential target node 203 may send a response to the CHO request sent at 204. For example, the potential target node 203 may send a CHO request ACK (e.g., RRCReconfiguation) at 206.

The source node 202 may send a CHO configuration at 208. For example, the CHO configuration sent at 208 may include one or more CHO triggering conditions or measurements, such as, an A3/A5 event and/or RRCReconfiguration. At 210, the WTRU 201 may monitor/evaluate the CHO triggering condition(s) and/or measurement events for the target cell(s) or candidates. If, for example, one or more of the CHO triggering condition(s) and/or measurement events are met for a given target cell or candidate, the WTRU 201 may execute handover with that cell or candidate at 212. The WTRU 201 may then send a CHO configuration to the potential target node 203 at 214. And at 216, the path switch may be confirmed and/or completed. Also, or alternatively, the WTRU's context may be released.

CHO may also be used to prevent unnecessary re-establishments in case of a radio link failure. For example, WTRU may be configured with multiple CHO targets and the WTRU may experience an RLF before the triggering conditions with any of the targets gets fulfilled. In certain techniques, the WTRU may initiate an RRC re-establishment procedure, which may incur considerable interruption time for the bearers of the WTRU. However, in the case of CHO, if, after detecting an RLF, if the WTRU ends up on a cell for which it has a CHO associated with (e.g., the target cell is already prepared for it), the WTRU may execute the HO command associated with this target cell directly, e.g., instead of continuing with the full re-establishment procedure.

CPC and CPA may be considered extensions of CHO, but in the DC scenario. A WTRU may be configured with triggering conditions for PSCell change or addition, and when the triggering conditions are fulfilled, the WTRU may execute the associated PSCell change or PSCell add commands.

CHO may be associated with the one or more events. One or more of the following may apply. CHO may be associated with a CondEvent A3, a CondEvent A4, and/or a CondEvent A5. CondEvent A3 may be used for conditional reconfiguration when a candidate becomes better than PCell/PSCell by a given offset. CondEvent A4 may be used for conditional reconfiguration when a candidate becomes better than absolute threshold. CondEvent A5 may be used when a PCell/PSCell becomes worse than absolute threshold1 and a conditional reconfiguration candidate becomes better than another absolute threshold2.

Turning off some cells and/or putting them in low power state (e.g., operate in cell DTX) may be used to achieve network energy savings, e.g., by reducing the amount of power consumed by the network equipment associated with those cells. By selectively turning off cells that are not heavily utilized or strategically reducing the number of cells in a certain area, the network may operate more efficiently, e.g., by reducing energy consumption and costs while maintaining adequate coverage and capacity. Energy savings may be realized over time, which may also reduce the environmental impact of the network and/or improve network sustainability, for example during times of low demand (e.g., at night). In certain scenarios, however, information that is used to determine which cell to turn off or transition to another NES state (e.g., cell DTX) without causing performance degradation of other users may not be readily available at the network. If, for example, the WTRUs (e.g., all the WTRUs) under a cell are configured with periodic measurement reporting, the network may obtain information associated with the number of WTRUs in the cell that will be able to off loaded to neighboring cells (e.g., via CHO, via normal HO before the NES state is changed, etc.). The networks attempt(s) to obtain such information may increase signaling overhead, increase WTRU power consumption, etc. Also, or alternatively, WTRUs that are under very good coverage of the serving cell (e.g., near the cell center where serving cell quality>s-measure) may not be performing neighbor cell measurements (e.g., based on respective configuration). Thus, the network may identify the radio situation of the WTRUs being served in each cell that supports NES without the need to configure every WTRU with a periodic measurement reporting. For example, if the network identifies this information, the network may offload WTRUs that are able to be served by another cell if the current cell is turned off without significant interference.

A WTRU may receive configuration information associated with suitability determinations for a set of neighbor cells. For example, the configuration information may include one or more suitability conditions, and a time duration. The WTRU may perform cell quality measurements on the set of neighbor cells in response to a trigger. The WTRU may determine whether a suitability condition of the one or more suitability conditions is met for a neighbor cell of the set of neighbor cells within the time duration. For example, this determination may be based on the cell quality measurements performed on the neighbor cells in response to the trigger. The WTRU may send an indication that includes information associated with the determination of whether the suitability condition of the one or more suitability conditions is met. For example, the indication that includes the information associated with the suitability determination may be sent via a medium access control (MAC) control element (CE), a scheduling request (SR), uplink control information, or a radio resource control (RRC) message.

As described herein, the WTRU may perform cell quality measurements on the set of neighbor cells in response to a trigger. For example, the trigger to perform measurements on the set of neighbor cells may include an indication that a network is to enter a network energy savings (NES) state. The trigger to perform measurements on the neighbor cells may also, or alternatively, include a determination that a serving cell associated with the WTRU is to be turned off (e.g., based on receiving a configuration message). The trigger to perform measurements on the set of neighbor cells may also, or alternatively, include a determination that a serving cell associated with the WTRU is to reduce transmit power. Also, or alternatively, the trigger may include any suitable indication that a cell (e.g., the WTRU's serving cell and/or one or more neighbor cells) will enter an NES state that may cause the cell to turn off and/or otherwise be partially available (e.g., cell DTX state, etc.) and/or operate at a lower power/capacity.

In certain circumstances, the WTRU may determine that the suitability condition of the one or more suitability conditions is not met for the set of neighbor cells within the time duration. If the WTRU determines that the suitability condition of the one or more suitability conditions is not met for the set of neighbor cells within the time duration, the information sent by the WTRU may include measurement results for a subset of the set of neighbor cells.

As described herein, the WTRU may receive configuration information that includes one or more suitability conditions. For example, the one or more suitability conditions may include: a condition that a cell quality measurement is greater than a threshold, and/or a condition that a cell quality measurement for a neighbor cell is greater than a cell quality measurement for a serving cell.

A WTRU may receive configuration information that is used for suitability determinations for neighbor cells (e.g., a set of the neighbor cells). The WTRU may receive an indication of the set of neighbor cells (e.g., stable cells). The configuration information may comprise one or more suitability conditions, and a time duration. The WTRU may determine whether a suitability condition of the one or more suitability conditions is met for a neighbor cell of the set of neighbor cells based on measurements (e.g., measurements performed on the set of neighbor cells over a period of time). The WTRU may send an indication that includes an information (e.g., a result) associated with the determination of whether the triggering condition is met. The WTRU may determine information associated with a NES operation of the WTRU's serving cell. For example, the WTRU may perform measurements on the set of neighbor cells in response to the determination of the information associated with the NES operation of the serving cell, which may be used to determine whether a triggering condition is met during the time duration. A WTRU may be configured to indicate the availability or non-availability of neighbor cells for a handover. Based on this indication, the network may identify cells that should be kept on and/or the cells that can be turned off or put to a lower power state (e.g., cell DTX). For example, the cells that are determined to be kept on may include cells that, if turned off, will cause some WTRUs to be out-of-coverage, experience RLF, and/or re-establish a connection with a cell that is far away, which may result in increased interference. The WTRU may be configured to send an indication/report that informs the network whether the WTRU is able to detect a neighbor cell with suitable radio conditions that the WRTU can be handed over to.

One or more of the following me be used by a WTRU to determine if suitable cells are not available for handover. The WTRU may receive a configuration (e.g., configuration information) of a condition (e.g., one or more suitability conditions) that a cell (e.g., a neighbor cell) must satisfy to be considered suitable for a handover (e.g., cell quality is greater than a configured threshold, cell quality is greater than the serving cell by more than a configured threshold, etc.). The WTRU may receive a configuration of a time duration to search for suitable cells. The WTRU may receive an indication of the NES operation of a cell (e.g., the WTRU's serving cell). The NES indication may be provided to the WTRU in a dedicated manner (e.g., dedicated DCI, MAC CE, RRC message, etc. ,) and/or via a broadcast/group manner (e.g., group common DCI, SIB signaling, etc.). For example, the indication of the NES operation of the cell may include an indication that the cell may be turned off within a given time, an indication that the DTX will be activated for the cell within a given time, and/or the like. Also, or alternatively, the WTRU may determine the NES operation timing relatively (e.g., the cell may be turned off between absolute time t1 and t2). The WTRU may start performing measurements on neighbor cells (e.g., even if the serving cell is above s-measure threshold) in response to these indications. For example, the indications described herein may be received and/or used by the WTRU as trigger to perform cell quality measurements on the set of neighbor cells. For example, the trigger may include any suitable indication that a cell (e.g., the WTRU's serving cell and/or one or more neighbor cells) will enter a state that may cause the cell to turn off and/or otherwise not be available (e.g., enter an NES state, DRX state, etc.). If the WTRU cannot find a suitable neighbor cell within the configured time duration, the WTRU may send an indication that there are no neighbor cells that satisfy the configured condition to the network (e.g., via MAC CE, SR, UCI, RRC message, etc.). For example, the indication may include measurement results of the neighbor cells and/or a subset of the neighbor cells (e.g., best n cells).

One or more of the following may be used by the WTRU to determine when a cell (e.g., among a list of stable cells) becomes suitable for handover. The WTRU may be configured with a list of stable cells (e.g., stable cells that will never turn off, such as, macro cells). The list of stable cells may include a list of stable cells per serving cell, and/or a general list of PCIs for the whole network, a tracking area, etc. The configuration may also include a condition (e.g., a suitability condition) that the stable cell must satisfy to be considered as suitable for a handover (e.g., alternative cell quality above a configured threshold, alternative cell quality above the serving cell by more than a configured threshold, etc.). The WTRU may receive an indication that triggers the WTRU to start performing/evaluating measurements regarding the stable cells for a time duration (e.g., a configured time duration). For example, the indication may inform the WTRU that the serving cell may start operating in NES mode within a given time, which may trigger the WTRU to perform cell quality measurements on the set of configured alterative cells. Also, or alternatively, the trigger may include any suitable indication that a cell (e.g., the WTRU's serving cell and/or one or more neighbor cells) will enter a state that may cause the cell to turn off and/or otherwise not be available (e.g., enter an NES state, DRX state, etc.). The WTRU may start performing/evaluating the measurements of the configured alterative cells. If the WTRU determines that at least one of the stable cells is suitable for handover (e.g., at least one of the cells meets a suitability condition) within the configured time duration, the WTRU may send an indication that there is a suitable stable cell to the network (e.g., via MAC CE, SR, UCI, RRC message, etc.). For example, the indication may include the measurement results of stable cells and other neighbor cells.

A WTRU may receive configuration information that comprises a set of measurement events that are associated with a set of stable cells. For example, the set of stable cells may comprise cells that are not configured to enter a NES state. The set of stable cells may include at least one macro cell and/or at least one reference cell. The reference cell may be a cell that is associated with a certain radio access technology, and/or a cell that is associated with a certain operating frequency. The WTRU may perform measurements on each cell in the set of stable cells in response to a trigger. For example, the trigger may be an indication that a serving cell associated with the WTRU is to enter an NES state. Also, or alternatively, the trigger may include any suitable indication that a cell (e.g., the WTRU's serving cell and/or one or more neighbor cells) will enter a state that may cause the cell to turn off and/or otherwise not be available (e.g., enter an NES state, DRX state, etc.). The WTRU may determine whether a measurement event of the set of measurement events is met for a cell of the set of stable cells within a period of time. For example, this determination may be based on the measurements performed for the period of time. In certain scenarios, the determination of whether a measurement event of the set of measurement events is met for a cell may include comparing measurements for the reference cell with at least one of a threshold, or other measurements for the set of stable cells. The WTRU may send an indication that includes an information associated with the determination of whether the measurement event is met.

A WTRU may be configured to receive configuration information that comprises a set of measurement events that are associated with a set of stable cells. The set of stable cells may further comprise a subset of cells that are reference stable cells. For example, the configuration information may further indicate that the WTRU is to consider each cell in the set of stable cells as the WTRU's serving cell when evaluating the measurement events. The WTRU may perform measurements for each cell in the set of stable cells in response to a trigger (e.g., receiving a trigger). For example, the trigger to perform measurements for each cell in the set of stable cells may include an indication that the WTRU's serving cell is to transition to a network energy savings (NES) state (e.g., and/or a period of time upon which the transition is to occur). Also, or alternatively, the trigger may include any suitable indication that a cell (e.g., the WTRU's serving cell and/or one or more neighbor cells) will enter a state that may cause the cell to turn off and/or otherwise not be available (e.g., enter an NES state, DRX state, etc.). The WTRU may perform measurements on each cell in the set of stable cells in response to the received trigger and/or indication for a period of time. The WTRU may determine whether a measurement event of the set of measurement events is met for a cell of the set of stable cells, e.g., based on the measurements performed for the period of time. The WTRU may send an indication that includes a result of the determination of whether the measurement event is met.

A WTRU may be configured with one or more measurement event(s) where the WTRU is to consider an stable cell as the WTRU's serving cell when performing/evaluating the measurement events. The network may identify stable cell(s) that are suitable for WTRUs after turning off current cells (e.g., NES/non-stable cells) and/or determine if the stable cells(s) are going to be reliable serving cells (e.g., cells that are unlikely lead to subsequent handover). The WTRU may be configured with stable cell. The WTRU may consider this configured set stable cell as if it is the WTRU's serving cell in evaluating measurement reporting events. One or more of the following may apply.

A WTRU may be configured with a list of stable cells (e.g., cells that will not turn off, e.g., macro cells, as described herein). One or more of the stable cells may also be configured as reference stable cell(s). The WTRU may also be configured with one or more measurement events where the WTRU considers the signal level of a given reference stable cell as the WTRU's serving cell's signal level, when evaluating the suitability conditions for those respective measurement events. The WTRU may receive an trigger to perform measurements concerning the reference stable cell(s) and evaluate the configured event conditions for a given configured time duration. For example, the trigger may inform or indicate to the WTRU that a serving cell may operate in NES mode within a given time. After that time duration has elapsed, the WTRU may send an indication/report to the network if the conditions for triggering the report have been fulfilled. For example, the indication may include measurement results of reference stable cell(s), non-reference stable cell, non-stable neighbor cells, and/or serving cells.

A WTRU may receive configuration information associated with conditional handover (CHO) for a set of stable cells. The WTRU may also receive configuration information associated with CHO for a set of non-stable cells. The WTRU may receive a CHO priority indication (e.g., via a transmission). For example, the CHO priority indication may include an indication to prioritize stable cells for CHO or an indication to prioritize non-stable cells for CHO. The CHO priority indication may be received via at least one of: the received configuration information associated with CHO for the set of stable cells, or the received configuration information associated with CHO for the set of non-stable cells. The WTRU may determine whether at least one CHO triggering condition is met for a cell in response to a CHO trigger based on the received CHO priority indication. For example, the received CHO priority indication may be an indication that a serving cell associated with the WTRU is to enter an NES state and/or an indication of a time that the serving cell associated with the WTRU is to enter the NES state.

In certain scenarios, the CHO priority indication may include the indication to prioritize stable cells. If the CHO priority indication includes the indication to prioritize stable cells, the WTRU may determine that the at least one CHO triggering condition is not met for any cell in the set of stable cells during a first period time. in response to the determination that the CHO triggering conditions is not met for any cell in the set of stable cells during the first period time, the WTRU may determine whether the at least one CHO triggering condition is met for any cell in the set of stable cells or any cell in the set of non-stable cells during a second period time. The WTRU may also, or alternatively, determine that the at least one CHO triggering condition is not met for any cell in the set of stable cells or any cell in the set of non-stable cells during the second period time. In response to the determination that the at least one CHO triggering condition is not met for any cell in the set of stable cells or any cell in the set of non-stable cells during the second period time, the WTRU may send an indication that includes information associated with the determination that the CHO triggering conditions is not met for any cell in the set of stable cells during the first period time and the determination that the at least one CHO triggering condition is not met for any cell in the set of stable cells or any cell in the set of non-stable cells during the second period time.

A WTRU may be configured to receive configuration information associated with conditional handover (CHO) for a set of stable cells, and configuration information associated with CHO for a set of non-stable cells. The WTRU may receive a priority indication (e.g., a CHO priority indication) that comprises an indication to prioritize stable cells or an indication to prioritize non-stable cells. The WTRU may determine whether a CHO triggering condition is met for any cell in a first set of cells based on the CHO priority indication. If, for example, the CHO priority indication comprises the indication to prioritize stable cells, the WTRU may determine that the CHO triggering conditions is not met for any cell in the first set of cells (e.g., stable cells) during a first period time. And, in response to the determination that the CHO triggering conditions is not met for any cell in the first set of cells during the first period time, the WTRU may determine whether the CHO triggering conditions is met for any cell in the first set of cells or a second set of cells during a second period time. If, for example, the WTRU determines that the CHO triggering conditions is not met for any cell in the first set of cells or the second set of cells during the second period time, the WTRU may send an indication that includes a result that determination.

A WTRU may be configured to fallback to stable cells when the WTRU is unable to perform CHO to non-stable cells (e.g., or vice versa). One or more of the following may apply. For example, the WTRU may be configured to fallback to stable cells to prevent overloading in stable cells (e.g., to prevent a situation where all/most of the WTRU execute a CHO to stable cells upon detecting NES state change of their serving cells) and/or to expediate energy saving over a given area (e.g., when the stable cells are not overloaded).

A WTRU may be configured with CHO configurations towards stable cells (e.g., macro cells that won't be turned off) and/or non-stable cells (e.g., NES capable micro cells). The WTRU may be further configured to determine whether to evaluate/execute CHO towards a stable cell, e.g., if (e.g., only if) the WTRU is unable to trigger the CHO to a non-stable cell (e.g., or vice versa). The WTRU may be configured with a CHO towards one or more stable cells (e.g., cells that will never be turned off, e.g., macro cells). The WTRU may be configured with a CHO towards one or more non-stable cells (e.g., cells that support NES and may be turned off). The WTRU may prioritize CHO towards the stable cells and/or the non-stable cells. The WTRU may be configured with the prioritization (e.g., prioritize stable cells or prioritize non-stable cells) as part of the CHO configurations or another configuration (e.g., dedicated signaling or broadcast/group signaling). For example, the priority configuration may include a first time duration (e.g., prioritization_duration) which may indicate the period of time that the configured priority is active. The priority configuration may also include a second time duration that indicates a time duration after the first time duration has elapsed. The WTRU may receive an indication to start evaluating the CHO triggering conditions. For example, the indication may inform the WTRU that a serving cell may start operating in NES mode within a given time. If, for example, stable cells were prioritized, the WTRU may evaluate the CHO triggering conditions towards the stable cells. If, however, non-stable cells are prioritized, the WTRU may evaluate the CHO triggering conditions towards the non-stable cells.

If the WTRU identifies a cell (e.g., stable cell if stable cells are prioritized, non-stable cell if non-stable cell are prioritized) that satisfies the triggering conditions of the CHO before the prioritization_duration has elapsed, the WTRU may execute the CHO towards the concerned stable or non-stable cell and send an indication of the CHO to the network.

If, however, the WTRU does identify not a cell that satisfies the triggering conditions of the CHO before the prioritization_duration elapses, the WTRU may evaluate the CHO triggering conditions for both stable and non-stable cells. If the WTRU finds a stable/non-stable cell that fulfills the CHO triggering conditions before the second time duration has elapsed, the WTRU may execute the CHO towards the concerned stable/non-stable cell and send an indication to the network. Otherwise, the WTRU may send an indication to the network that the WTRU failed to identify a stable or non-stable target that fulfills the CHO conditions.

As described herein, UCI may include: CSI, HARQ feedback for one or more HARQ processes, Scheduling request (SR), Link recovery request (LRR), CG-UCI and/or other control information bits that may be transmitted on the PUCCH or PUSCH.

As described herein, channel conditions may include: any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, and/or channel availability in unlicensed spectrum (e.g., whether the channel is occupied based on determination of an LBT procedure or whether the channel is deemed to have experienced a consistent LBT failure).

As described herein, an indication by DCI, or an indication, may include of at least one of the following: an explicit indication by a DCI field or by RNTI used to mask CRC of the PDCCH; an implicit indication by a property such as DCI format, DCI size, coreset or search space, aggregation level, identity of first control channel resource (e.g., index of first CCE) for a DCI, where the mapping between the property and the value may be signaled by RRC or MAC; and/or an explicit indication by a DL MAC CE.

The terms network availability state, cell turned off, cell DTX mode/configuration, or NES state may be used interchangeably. The WTRU may determine a cell DTX/DRX state implicitly from a determined active availability state, and visa-versa.

Although the techniques described herein are described within the context of network energy saving (e.g., to determine which cells can be turned off, etc.), they are equally applicable to other scenarios, including, for example, where the network may use information about the best cells from a multitude of WTRUs (e.g., for load balancing, interference mitigation, etc.). Similarly, although the techniques described herein are described within the context of L3 mobility (e.g., RRC measurement reporting events, CHO configurations, etc.), they are also, or alternatively, equally applicable to other mobility scenarios (e.g., L1/L2 controlled mobility, e.g., LTM, L1 measurement reporting events, etc.)

A WTRU may be configured with information (e.g., configuration information) about neighbor cells. The WTRU may be configured to consider a (e.g., any) detectable neighbor cell as a possible candidate target cell (e.g., any frequency, RAT, etc.). Also, or alternatively, the WTRU may be configured to consider a subset of the detectable cells as a possible candidate target cell, e.g., based on one or more of the following criteria. For example, the WTRU may consider (e.g., only consider) cells utilizing a certain RAT(s) (e.g., NR cells only, LTE cells only, both NR and LTE, etc.) as a possible candidate target cell. The WTRU may not consider cells utilizing a certain RAT (e.g., do not consider LTE cells) as a possible candidate target cell. The WTRU may consider (e.g., only consider) cells operating at a certain frequency or set/range of frequencies (e.g., FR1 only, FR2 only, both FR1 and FR2, etc.) as a possible candidate target cell. The WTRU may not consider cells operating at a certain frequency (e.g., not consider FR2 cells) as a possible candidate target cell. The WTRU may consider (e.g., only consider) cells belonging to a certain group (e.g., tracking area, ran area, PLMN, explicit list of cells, etc.) as a possible candidate target cell. The WTRU may not consider cells belonging to a certain group as a possible candidate target cell. The WTRU may consider whether the neighbor cell is part of a configured list of stable cells (e.g., which can be determined as a function of the serving/source cell or more generally as a list regardless of the serving cell) in determining if a cell is a possible candidate target cell. The WTRU may for example not consider cells that are not configured as stable cells as a possible candidate target cell. The WTRU may consider whether the neighbor cell is part of a configured list of stable cells that will not apply any NES techniques (e.g., not turn off, not apply cell DTX, etc.) in determining if a cell is a possible candidate target cell. The WTRU may for example not consider cells not configured as stable cells as a possible candidate target cell. The WTRU may consider stable cells as detectable, for example, after (e.g., only after) evaluating other neighbor cells (e.g. CHO candidates) or visa-versa.

As described herein, a WTRU may be configured to prioritize cells based on the RAT, frequency, cell group, configuration of stable cells, configuration of stable cells, etc. The WTRU's configuration to consider (e.g., or not consider) a cell as a possible candidate target cell or which cells or types of cells to prioritize may be dependent on the current time (e.g., consider all RATs/frequencies during a certain time period of the day, consider only certain RATs/frequencies/list of cells at another time period, prioritize RAT1 over RAT2 during a certain time period but prioritize RAT2 over RAT1 at another time period, etc.). The WTRU's configuration to consider (e.g., or not consider) a cell as a possible candidate target cell or which cells or types of cells to prioritize may be dependent on the current serving cell of the WTRU, e.g., serving cell identity, serving cell's frequency, serving cell's RAT time, and/or the physical location of the WTRU, e.g., GNSS location.

As described herein, a WTRU's configuration to consider (e.g., or not consider) a cell as a possible candidate target cell or which cells or types of cells to prioritize may be dependent on the WTRU's current mobility state (e.g., do not consider cells of FR2 when moving at a high speed, consider both FR1 and FR2 cells when stationary or moving at low speed, etc.)

As described herein, the WTRU may receive the configuration regarding what cells/frequencies/RATs to consider and prioritization among cells/frequencies/RATs, etc. via dedicated signaling (e.g., RRC reconfiguration), broadcast signaling (e.g., SIB), or a combination of the two.

A WTRU's configuration to consider (e.g., or not consider) a cell as a possible candidate target cell or which cells or types of cells to prioritize may be dependent on the NES state associated with the target cell. Also, or alternatively, the WTRU's configuration to consider (e.g., or not consider) a cell as a possible candidate target cell or which cells or types of cells to prioritize may be dependent on whether the target cell is configured with at least one NES technique (e.g., cell DTX, spatial element adaptation, PA power reduction, turn off, PA sleep, etc.).

The WTRU's configuration to consider (e.g., or not consider) a cell as a possible candidate target cell or which cells or types of cells to prioritize may be dependent on a channel condition measurement associated with the current serving cell of the WTRU and/or the target cell.

In all of the following solutions, the UE's priority of the stable vs non-stable cells depends upon the nature of its serving cell. In one example, if the PCell of the WTRU is a stable cell, the WTRU can be configured to prioritize the set of stable cells over the set of non-stable cells for all the solutions/procedures proposed herein. In another example, the non-stable cells can be configured prioritized when UE's PCell is a stable cell.

As described herein, the priority assignments may be configured differently for FR1 and FR2. For example, a WTRU may be configured to prioritize a set of cells if the WTRU is operating in FR1 and configured to prioritize another set of cells if the WTRU is operating in FR2. As described herein, the WTRU may determine which set of cell to prioritize based on the CHO priority indication.

A WTRU may be configured with information associated with stable cells. For example, the WTRU may be configured with a list of stable cell, which may, for example, include: stable cells that will never turn off, cells that are not configured with at least one NES technique (e.g., cell DTX, spatial element adaptation, PA power reduction, turn off, PA sleep, etc.), macro cells, and/or cells that are not currently applying an NES technique. The list of stable cells may be provided to the WTRU via signaling (e.g., dedicated signaling, such as an RRC message). The list of stable cells may also, or alternatively, be provided to the WTRU via common signaling (e.g., SIB). As described herein, the list of stable cells may be updated over time, e.g., based on measurements performed by WTRU(s).

The WTRU may consider neighbor cells that do not support NES as stable cells. The WTRU may consider neighbor cells that are not configured with NES as stable cells. The WTRU may consider neighbor cells that are not actively applying an NES technique as stable cells (e.g., when a NES technique is deactivated). The WTRU may determine that a NES technique is deactivated based on signaling (e.g., common signaling of such target cell and/or from information provided by the source cell).

The WTRU may consider neighbor cells (e.g., all neighbor cells) as stable cells.

The list of stable cells may be associated with a given serving cell (e.g., cells a, b, and c are configured as stable cells when the WTRU is being served by a first cell, cells d and e are configured as stable cells when the WTRU is being served by cell 2, etc.). The WTRU may determine the applicable list of stable cells for a given serving/source cell based on: broadcast/common configurations on the cell; the reception of RRC configurations from the cell with such information, and/or the reception of a MAC CE from the source cell with such information. Upon reception of signaling from the source/serving cell (e.g., MAC CE or RRC signaling) that indicates the applicable stable cells, the WTRU may ignore other global stable cells that are pre-configured or indicated by common signaling.

The stable cells may be applicable while the WTRU is served by any serving cell. The stables cells may be configured as a list of cell identities (e.g., PCIs/CGIs), a range of PCIs, tracking areas, frequencies, etc.

As described herein, a WTRU may fallback to stable cells if, for example, the WTRU is unable to perform CHO to non-stable cells (e.g., or vice-versa). One or more of the following may apply. For example, the WTRU may be configured to fallback to stable cells to prevent overloading in stable cells (e.g., to prevent a situation where all/most of the WTRU execute a CHO to stable cells upon detecting NES state change of their serving cells) and/or to expediate energy saving over a given area (e.g., when the stable cells are not overloaded).

A WTRU may be configured with CHO prioritization configurations towards stable cells (e.g., macro cells that won't be turned off) and/or non-stable cells (e.g., NES capable micro cells). The WTRU may be further configured to determine whether to prioritize evaluating/executing CHO towards a stable cell, e.g., if (e.g., only if) the WTRU is unable to trigger the CHO to a non-stable cell (e.g., or vice versa). The WTRU may be configured to prioritize CHO towards one or more stable cells (e.g., cells that will never be turned off, e.g., macro cells) via a CHO priority indication. For example, the CHO priority indication may include an indication to prioritize stable cells for CHO or an indication to prioritize non-stable cells for CHO. In certain scenarios, the WTRU may be configured with a CHO priority indication to prioritize one or more non-stable cells (e.g., cells that support NES and may be turned off). The WTRU may prioritize CHO towards the stable cells and/or the non-stable cells.

The WTRU may receive the CHO priority indication (e.g., prioritize stable cells or prioritize non-stable cells) as part of the CHO configurations or another configuration (e.g., dedicated signaling or broadcast/group signaling). For example, the CHO priority indication may include a first-time duration (e.g., prioritization_duration) which may indicate the period of time that the configured priority is active. The CHO priority indication may also include a second time duration that indicates a time duration after the first time duration has elapsed. The WTRU may receive a trigger (e.g., a CHO trigger) to start evaluating the CHO triggering conditions. For example, the CHO trigger may inform the WTRU that a serving cell may start operating in NES mode within a given time. If, for example, stable cells were prioritized, the WTRU may evaluate (e.g., may first evaluate) the CHO triggering conditions towards the stable cells. If, however, non-stable cells are prioritized, the WTRU may evaluate the CHO triggering conditions towards the non-stable cells.

If the WTRU identifies a cell (e.g., stable cell if stable cells are prioritized, non-stable cell if non-stable cell are prioritized) that satisfies the CHO triggering condition(s) before the prioritization_duration has elapsed, the WTRU may execute the CHO towards the concerned stable or non-stable cell and send an indication of the CHO to the network.

If, however, the WTRU does not identify a cell that satisfies the CHO triggering condition(s) before the prioritization_duration elapses, the WTRU may evaluate the CHO triggering conditions for both stable and non-stable cells. If the WTRU finds a stable/non-stable cell that fulfills the CHO triggering conditions before the second time duration has elapsed, the WTRU may execute the CHO towards the concerned stable/non-stable cell and send an indication to the network. Otherwise, the WTRU may send an indication to the network that the WTRU failed to identify a stable or non-stable target that fulfills the CHO conditions.

A WTRU may be configured to prioritize CHO towards stable and non-stable cells. For example, the WTRU may be configured with a CHO configuration that indicates that the target cell is one or more of: a stable cell; and/or a non-stable cell. The triggering conditions for the cells (e.g., all the target) cells may be the same (e.g., condA3 like CHO configuration where the target cell must be better than the serving cell by more than a certain threshold). The triggering conditions for the stable cells may also, or alternatively, be different from that of the non-stable cells (e.g., one condA3 threshold for stable cells, another condA3 threshold for non-stable cells). The triggering conditions may also, or alternatively, be different for all the stable and all the non-stable cells (e.g., each target cell having a different condA3 threshold).

A WTRU may be configured to prioritize CHO towards stable cells. For example, the WTRU may be configured to start evaluating the CHO conditions for the stable cells. If (e.g., only if) none of the stable cells fulfilled the conditions within a first configured time duration/period, the WTRU may start evaluating the CHO conditions for the non-stable cells. At the end of the first time period, the WTRU may stop evaluating the CHO conditions for the stable cells. At the end of the first time period, the WTRU may also, or alternatively, continue evaluating the CHO conditions for the stable cells.

The WTRU may be configured with a second time duration/period. For example, the second time duration/period may start at the end of the first time duration. At the end of the second time duration, the WTRU may stop performing the CHO evaluations of the non-stable cells (e.g., and also stable cells, for example, if the WTRU was configured to keep evaluating the CHO of these cells after the first duration) if no target fulfilled the CHO conditions.

The WTRU may execute the CHO concerning the stable cell during the second time duration, e.g., if the CHO conditions are simultaneously fulfilled for a stable cell and a non-stable cell.

Also, or alternatively, a WTRU may be configured to prioritize CHO towards non-stable cells. For example, the WTRU may be configured to start evaluating the CHO conditions for the non-stable cells. If (e.g., only if) none of the non-stable cells fulfilled the conditions within a first configured time duration/period, the WTRU may start evaluating the CHO conditions for the stable cells.

The WTRU may be configured to evaluate a subset of non-stable cells. For example, the subset of non-stable cells may include non-stable cells that the WTRU knows (e.g., through (pre-)configuration or signaling) that the network is not putting in a NES low energy mode). The NES low energy mode may indicate DTX, deep, macro or micro sleep.

At the end of the first time period, the WTRU may stop evaluating the CHO conditions for the non-stable cells. Also, or alternatively, the WTRU may continue evaluating the CHO conditions for the non-stable cells at the end of the first time period.

The WTRU may be configured with a second time duration/period, that is started at the end of the first time duration. At the end of the second time duration, the WTRU may stop performing the CHO evaluations of the stable cells (e.g., and also non-stable cells, for example if the WTRU is configured to keep evaluating the CHO of these cells after the first duration), if no target fulfilled the CHO conditions. The WTRU may be configured to execute the CHO concerning the non-stable cell during the second time duration, e.g., if the CHO conditions are simultaneously fulfilled for a stable cell and a non-stable cell.

A WTRU may perform one or more of the following after the end of the first/second duration and/or after CHO condition fulfillment. The WTRU may be configured to stop evaluating the CHO conditions for the stable and non-stable cells, e.g., if no target fulfilled the CHO conditions after the second duration. The WTRU may be configured to stop evaluating the CHO conditions for the stable and/or non-stable cells, e.g., if a target fulfilled the CHO conditions during the first or the second duration.

If, for example, the WTRU has not found any CHO targets that fulfill the CHO conditions after the first duration, the WTRU may send an indication to the network. For example, the indication may indicate that: no stable cells were found that fulfilled the CHO conditions (e.g., if CHO towards stable cells were prioritized), no non-stable cells was found that fulfilled the CHO conditions (e.g., if CHO towards non-stable cells were prioritized), etc.

If, for example, the WTRU has not found any CHO targets that fulfill the CHO conditions after the second duration, the WTRU may send an indication to the network. For example, the indication may indicate that no stable or non-stable cells were found that fulfilled the CHO conditions, etc.

In certain scenarios, the WTRU may send an indication to the network (e.g., a separate indication, a CHO complete indication, etc.), e.g., if the CHO conditions are fulfilled during the first or the second time duration,

The WTRU may include measurement results of stable cells, non-stable cells, serving cells, etc. in any of the indications described herein.

The indication for the WTRU to prioritize stable cells or non-stables may be part of the CHO configurations (e.g., a priority level included in the CHO configurations, for example, where the CHO configuration of the stable cells having a priority of 1, while the CHO configuration of the non-stable cells having a priority of 2, etc.). The WTRU may also, or alternatively, be configured to prioritize the stable cells or the non-stable cells separately from the CHO configuration (e.g., a dedicated RRC/MAC/DCI, a common information via SIB or group DCI, etc.).

In certain scenarios, the WTRU may be configured to prioritize the cells based on an NES indication. For example, the cells (e.g., all the cells) declared by the network as candidates/targets for NES sleep mode may be assigned a lower priority, and/or the cells (e.g., all the cells) that are not indicated as candidates/targets for NES sleep mode may be assigned as higher priority.

In certain scenarios, the WTRU may determine one or more (e.g., two) partitions (e.g., sets) among the non-stable cells. A first set may include DISABLED non-stable cells which the network provides indication of turning OFF. Another set may include ACTIVE non-stable cells which network is keeping ON. The WTRU may also, or alternatively, receive an indication of a minimal time duration during which ACTIVE non-stable cells will stay awake. The WTRU may not consider DISABLED non-stable cells for one or more (e.g., any) signaling, measurement or as target CHO. The WTRU may treat ACTIVE non-stable cells as non-stable cells for measurement or CHO targets when configured to prioritize non-stable cells.

In certain scenarios, the WTRU may prioritize ACTIVE non-stable cells as CHO candidates, e.g., if the WTRU has the knowledge of ACTIVE non-stable cells and stable cells and the network has not indicated any priority for CHO by configuration or indication.

If, for example, the network has not provided any priority among the stable or non-stable cells for CHO purpose, the WTRU may prioritize the stable cells as CHO targets (e.g., if the WTRU current PCell that the WTRU is going to replace with a CHO target, is a stable cell, and vice versa).

The WTRU may be configured to change the priority level during performing the CHO evaluations, e.g., if the priority level was configured separately from the CHO configuration. For example, the WTRU may be configured to prioritize the stable cells, and while evaluating the CHO conditions for the stable cells, the WTRU may receive an indication to prioritize the non-stable cells. The WTRU may stop evaluating the CHO conditions of the stable cells and start evaluating the CHO conditions of the non-stable cells in response to such an indication.

The WTRU may be configured to wait until receiving an indication from the network to start evaluating the CHO conditions of any of the cells. For example, such an indication may be an indication that the serving cell will start operating in an NES mode within a given time duration.

Although the techniques described herein are in the context of stable and non-stable cells, they are equally applicable to any grouping of cells the WTRU may be configured with for CHO. For example, the WTRU may be configured with n number of group of cells (e.g., groups 1 to n), where the group1 has the highest priority, group 2 has the next priority and so on. The WTRU may also be configured with n-1 time durations/periods. The WTRU may start evaluating the CHO conditions for the cells in group1 first, and starts evaluating the CHO conditions for the cells in group2 (e.g., only if no cell in group1 fulfilled the CHO conditions during the first time duration). Similarly, the WTRU may start evaluating the CHO conditions for the cells in group3 if (e.g., only if), for example, no cell in group 2 (e.g., and group1, if the WTRU was configured to keep evaluating CHO for group1 even after first time duration) fulfilled the CHO conditions, etc.

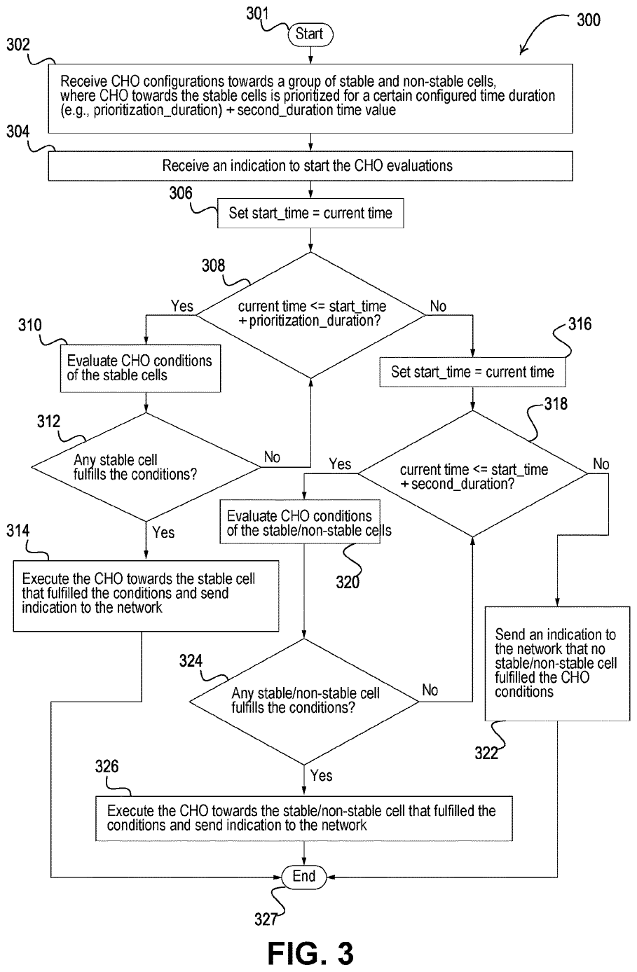

FIG. 3 illustrates an example procedure 300 associated with a WTRU performing prioritized CHO towards stable/non-stable cells. As shown in FIG. 3, the WTRU may be configured to prioritize the stable cells and continue evaluating the CHO conditions of the stable cells even after the prioritization duration has elapsed. The procedure 300 may being at 301. At 302, the WTRU may receive CHO configurations associated with a group of stable and non-stable cells, where CHO towards the stable cells is prioritized for a certain configured time duration (e.g., prioritization_duration) +second_duration time value. As described herein, the CHO priority indication may include the indication to prioritize CHO towards the stable cells for the configured time duration (e.g., prioritization_duration) and/or the second_duration time value. At 304, the WTRU may receive a trigger for the WTRU to start evaluating the CHO triggering condition(s), e.g., based on the received CHO priority indication. Although the procedure 300 illustrates an example where the CHO priority indication includes the indication to prioritize CHO towards the stable cells, the CHO priority indication may alternatively indicate that the WTRU is to prioritize CHO towards other cells (e.g., non-stable cells).

At 306, the WTRU may set the start_time as the current time. At 308, the WTRU may determine whether the current time is less than or equal to the start_time plus the prioritization_duration. For example, as described herein, the prioritization_duration may be indicated in the configuration the includes CHO priority indication. If the current time is less than or equal to the start_time plus the prioritization_duration, the WTRU may evaluate the CHO triggering conditions of the stable cells at 310. At 312, the WTRU may determine whether any stable cell fulfills/meets the CHO triggering conditions. If the WTRU determines that a stable cell fulfills/meets the CHO triggering conditions, the WTRU may execute the CHO towards the stable cell that fulfilled the CHO triggering conditions and send indication to the network at 314, and the procedure 300 may end at 327.

If, however, the current time is not less than or equal to the start_time plus the prioritization_duration, the WTRU may set the start_time as the current time at 316. At 318, the WTRU may determine whether the current time is less than or equal to the start_time plus the second_duration. If the current time is not less than or equal to the start_time plus the second_duration, the WTRU may send an indication to the network that no stable/non-stable cell fulfilled the CHO triggering conditions at 322 and the procedure 300 may end at 327. If, however, the current time is less than or equal to the start_time plus the second_duration, the WTRU may evaluate the CHO triggering conditions for the stable and non-stable cells at 320. At 324, the WTRU may determine whether any stable or non-stable cell fulfills/meets the CHO triggering conditions. If the WTRU determines that a stable cell or a non-stable cell fulfills/meets the CHO triggering conditions, the WTRU may execute the CHO towards the cell that fulfilled the CHO triggering conditions and send indication to the network at 326, and the procedure 300 may end at 327.

What is claimed is:

1. A wireless transmit receive unit (WTRU) comprising a processor and a memory, the processor and the memory configured to:
receive configuration information associated with conditional handover (CHO) for a set of stable cells, wherein the set of stable cells comprises cells that are not configured to enter a network energy savings (NES) state;
receive configuration information associated with CHO for a set of non-stable cells;
receive a CHO priority indication, wherein the CHO priority indication comprises an indication to prioritize stable cells for CHO or an indication to prioritize non-stable cells for CHO; and
determine whether at least one CHO triggering condition is met for a cell in response to a CHO trigger, wherein the determination is based on the CHO priority indication.

2. The WTRU of claim 1, wherein the CHO priority indication comprises the indication to prioritize stable cells, and wherein the processor and the memory are further configured to:
determine that the at least one CHO triggering condition is not met for any cell in the set of stable cells during a first period time; and
in response to the determination that the CHO triggering conditions is not met for any cell in the set of stable cells during the first period time, determine whether the at least one CHO triggering condition is met for any cell in the set of stable cells or any cell in the set of non-stable cells during a second period time.

3. The WTRU of claim 2, wherein the processor and the memory are further configured to:
determine that the at least one CHO triggering conditions is not met for any cell in the set of stable cells or any cell in the set of non-stable cells during the second period time; and
in response to the determination that the at least one CHO triggering condition is not met for any cell in the set of stable cells or any cell in the set of non-stable cells during the second period time, send an indication that includes a result associated with the determination that the CHO triggering conditions is not met for any cell in the set of stable cells during the first period time and the determination that the at least one CHO triggering condition is not met for any cell in the set of stable cells or any cell in the set of non-stable cells during the second period time.

4. The WTRU of claim 2, wherein the CHO priority indication is received via a transmission, and wherein the transmission further comprises an indication of the first period of time and an indication of the second period of time.

5. The WTRU of claim 1, wherein the CHO priority indication is received via at least one of:
the received configuration information associated with CHO for the set of stable cells, or
the received configuration information associated with CHO for the set of non-stable cells.

6. The WTRU of claim 1, wherein the CHO trigger comprises an indication that a serving cell associated with the WTRU is to enter a NES state.

7. The WTRU of claim 6, wherein the CHO trigger further comprises an indication of a time that the serving cell associated with the WTRU is to enter the NES state.

8. A method performed by a wireless transmit receive unit (WTRU), the method comprising:
receiving configuration information associated with conditional handover (CHO) for a set of stable cells, wherein the set of stable cells comprises cells that are not configured to enter a network energy savings (NES) state;
receiving configuration information associated with CHO for a set of non-stable cells;
receiving a CHO priority indication, wherein the CHO priority indication comprises an
indication to prioritize stable cells for CHO or an indication to prioritize non-stable cells for CHO; and
determining whether at least one CHO triggering condition is met for a cell in response to a CHO trigger, wherein the determination is based on the CHO priority indication.

9. The method of claim 8, wherein the CHO priority indication comprises the indication to prioritize stable cells, and the method further comprises:
determining that the at least one CHO triggering condition is not met for any cell in the set of stable cells during a first period time; and
in response to the determining that the CHO triggering conditions is not met for any cell in the set of stable cells during the first period time, determining whether the at least one CHO triggering condition is met for any cell in the set of stable cells or any cell in the set of non-stable cells during a second period time.

10. The method of claim 9, further comprising:
determining that the at least one CHO triggering conditions is not met for any cell in the set of stable cells or any cell in the set of non-stable cells during the second period time; and
in response to the determining that the at least one CHO triggering condition is not met for any cell in the set of stable cells or any cell in the set of non-stable cells during the second period time, sending an indication that includes a result associated with the determination that the CHO triggering conditions is not met for any cell in the set of stable cells during the first period time and the determination that the at least one CHO triggering condition is not met for any cell in the set of stable cells or any cell in the set of non-stable cells during the second period time.

11. The method of claim 9, wherein the CHO priority indication is received via a transmission, and wherein the transmission further comprises an indication of the first period of time and an indication of the second period of time.

12. The method of claim 8, wherein the CHO priority indication is received via at least one of:
the received configuration information associated with CHO for the set of stable cells, or the received configuration information associated with CHO for the set of non-stable cells.

13. The method of claim 8, wherein the CHO trigger comprises an indication that a serving cell associated with the WTRU is to enter a NES state.

14. The method of claim 13, wherein the CHO trigger further comprises an indication of a time that the serving cell associated with the WTRU is to enter the NES state.
